(19) United States
(12) Patent Application Publication
(10) Pub. No.: US 2026/0044525 A1
(43) Pub. Date: Feb. 12, 2026

(54) CLOUD-BASED DATA MANAGEMENT SYSTEM

(71) Applicant: Attain Consulting Group, LLC DBA Attain Partners, McLean, VA (US)

(72) Inventors: Jason Hunter, Aurora, CO (US); Matthew Vaughn Roush, Brighton, CO (US)

(21) Appl. No.: 19/306,162

(22) Filed: Aug. 21, 2025

Related U.S. Application Data
(63) Continuation of application No. 18/784,514, filed on Jul. 25, 2024.
(60) Provisional application No. 63/515,490, filed on Jul. 25, 2023.

(51) Int. Cl. G06F 16/25; G06F 16/21; G06F 16/23

(52) U.S. Cl. CPC G06F 16/258; G06F 16/214; G06F 16/2358; G06F 16/2365

(57) ABSTRACT

This disclosure includes a process for merging legacy databases having different data schema into a principal data store. A computing device retrieves a legacy database from each of a plurality of domains of an organization to form a plurality of legacy databases, where at least two legacy databases in the plurality of legacy databases have a different data schema. For each of the plurality of legacy databases, the computing device retrieves data from the respective legacy database, places the data from the respective legacy database into a respective unstructured database, and merges the respective unstructured database into a principal data store designed to hold data for every domain of the plurality of domains.

### RELATED APPLICATIONS

This application is a continuation of U.S. patent application Ser. No. 18/784,514, filed Jul. 25, 2024, which claims the benefit of U.S. Provisional Application No. 63/515,490, filed Jul. 25, 2023, the entire contents of which are incorporated herein by reference.

### TECHNICAL FIELD

The present disclosure relates generally to cloud computing systems. In particular, but not by way of limitation, the present disclosure relates to systems, methods, apparatuses, and storage media for a cloud-based data management system for educational institutions.

### BACKGROUND OF THE INVENTION

Data migrations are complex, difficult, time consuming and expensive when handled as one-off efforts. In some circumstances, organizations (e.g., higher education institutions, such as colleges/universities) need to manage the large quantities of data they own in support of all of their domains with the limited skills, budget and/or resources at their disposal. Additionally, educational institutions and other similar institutions are often faced with bureaucratic hurdles and constraints not experienced by other organizations (e.g., a private company) performing data migrations. Furthermore, since colleges/universities and other similar institutions do not have the necessary skills, budget, and/or resources, they are lagging behind other organizations/companies when it comes to properly manage their data.

The description provided in the description of related art section should not be assumed to be prior art merely because it is mentioned in or associated with this section. The description of related art section may include information that describes one or more aspects of the subject technology.

### SUMMARY OF THE INVENTION

In general, the disclosure is directed to techniques for merging legacy databases having different data schema into a principal data store. A computing device retrieves a legacy database from each of a plurality of domains of an organization to form a plurality of legacy databases, where at least two legacy databases in the plurality of legacy databases have a different data schema. For each of the plurality of legacy databases, the computing device retrieves data from the respective legacy database, places the data from the respective legacy database into a respective unstructured database, and merges the respective unstructured database into a principal data store designed to hold data for every domain of the plurality of domains. When using unstructured databases, any previous insights gathered within domains would not be lost, but the leniency granted by unstructured databases means that data will not be duplicated in the principal data store, unlike a strict field-to-field migration.

Since there is no existing product that can properly manage college/university data migrations while meeting the skills, budget, resources, and/or bureaucratic constraints faced by these organizations, Applicant has developed the following cloud-based data management system to address these needs. The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

Some challenges faced by organizations, especially higher education institutions (Higher Ed), include resources (e.g., staffing/capacity), knowledge (e.g., technical capability), internal trust issues, lack of long-term vision and strategic investment, lack of unit-level sense of responsibility, and/or lack of interoperability between technologies. Broadly, aspects of the present disclosure are directed to a cloud-based data management system that can help accelerate higher-ed technology capabilities, provide them with a competitive edge, as well as help lower overall cost of migration and data management. While generally described with reference to higher-ed institutions, this is not intended to be limiting. The system of the present disclosure can support different types of organizations (e.g., non-profit organizations, start-up companies, etc.) with their data migration and/or data management needs.

Some aspects of the present disclosure are directed to a data intelligence cloud service system (also referred to as cloud-based data system). The cloud-based data system provides an open source, user-friendly, and education focused set of data tools. Specifically, but without limitation, aspects of the present disclosure may provide a higher education client (or another applicable entity, such as a high school, middle school, etc.) with one or more of (1) faster and/or more accurate data migration results, and (2) a flexible, vendor-agnostic, intelligent data management middleware platform that seamlessly allows data stored across the entity's multiple systems, platforms, and/or applications to be discovered, viewed, governed, integrated and processed. In some aspects, the present disclosure can help remove some of the traditional barriers typically seen while leveraging this data. Additionally, or alternatively, the present disclosure may facilitate making the data actionable for one or more of marketing purposes (e.g., new student marketing), advising purposes (e.g., new or existing student advising), donor management, recruiting (e.g., sports recruiting), and administrative functions, to name a few non-limiting example. The technology described herein is robust and empowered by customers and governance to ensure the usability, availability, security, and/or integrity of the data. Additionally, or alternatively, the plug and play and user-friendly nature of the system may help allow constituents to access the data they need to successfully manage their business.

The cloud-based data system facilitates low-maintenance with guaranteed uptime and built-in redundancy while simultaneously leading institutions away from traditional, on premises, resource dependent, and vulnerable systems requiring high levels of maintenance. The cloud-based system comprises (or is associated with) an application (e.g., mobile app, web app, or another applicable type of app) built on a multi-tenant architecture, where the application is hosted in a common runtime by default. In some cases, the cloud-based data system may also support the use of dedicated, isolated nodes (i.e., servers or computing clusters). One non-limiting example of a cloud-based system may include system 300 described in relation to FIG. 3.

Furthermore, the cloud-based data system may be more cost efficient (i.e., cheaper) and scalable, easier to upgrade and maintain, or a combination thereof, as compared to the prior art. In some cases, the cloud-based system supports multi-region redundancy, which helps enhance speed and reliability for geographically distributed teams (e.g., two or more universities in different countries or states collaborating on the same project). As noted above, one non-limiting example of a cloud-based system may include the system 300 described in relation to FIG. 3.

In some cases, the cloud-based data system enhances security for data and integrations with external applications and/or data services, as compared to the prior art. As noted above, one non-limiting example of a cloud-based system may include the system 300 described in relation to FIG. 3.

In some cases, the cloud-based data system is configured to provide periodic snapshots or updates (e.g., hourly, daily and/or weekly snapshots) of configurations, such as, but not limited to, connections between different applications, database structures, and visualizations of data flows. In some cases, the periodic snapshots facilitate in easier rollback to a previous configuration (e.g., if a new configuration is resulting in data access errors). Thus, in essence, the snapshots or backups are based on current best practices related to backup and snapshot technologies. As noted above, one non-limiting example of a cloud-based system may include the system 300 described in relation to FIG. 3.

In some cases, the cloud-based data system (e.g., system 300) supports data backup (e.g., full backup, which may be automatically performed on a daily, weekly and/or monthly basis). In some embodiments, a full backup may include a backup/snapshot of both configuration and data. In other cases, the cloud-based data system may perform a partial backup (e.g., one of config and data) at a first frequency (e.g., daily or weekly) and a full backup (e.g., both config and data) at a second frequency (e.g., monthly, quarterly). In some aspects, a full backup may allow the customer/client (e.g., Higher Ed institution) to perform a full-system reset as opposed to the limited reset offered by snapshots.

In some embodiments of the disclosure, open-source methodologies may be applied to an internal, proprietary system. For instance, the system of the present disclosure may allow collaborative development of code, config and/or governance while still being tailored to the higher ed institution and maintaining access/security protocols. As an example, the system of the present disclosure may allow an internal proprietary system (i.e., associated with a university or another similar entity) to work in conjunction with a third-party platform/system (e.g., GOOGLE, AMAZON, MICROSOFT, ORACLE) supporting open-source methodologies, which allows the open-source code and/or configurations to be tweaked in line with the needs of the customer (i.e., university or higher ed institution).

With regards to collaboration, in some embodiments, the system may allow users to contribute new ideas, sources and changes to configurations, code, and even documentation across one or more areas of the system/platform. In some cases, users may submit changes, e.g., via pull requests, which other users can review, comment and/or help iterate on the same.

With regards to governance, in some embodiments, the user provided suggestions or requests can be pulled into the integrated, transparent Information Technology (IT) governance process for review and potential adoption.

With regards to security, in some embodiments, the system/platform is configured to restrict external access, allow central administrators to manage internal access, or a combination thereof. In some cases, the system allows central administrators to manage internal access at a granular lever (as needed), for instance, allowing users to view code or configurations but not the data itself.

In some embodiments, the cloud-based data system includes built-in analytics and intelligence, e.g., standard and custom reporting tools; internal, configurable predictive AI tools, etc.

In some cases, the cloud-based data system includes “advanced intelligence tools” that leverage multi-tenant architecture to compare data and draw insights from a collective pool of data gathered from a plurality of client/participating institutions.

In some embodiments, the cloud-based data system comprises quick-start migration tools with plug and play support for legacy systems, which helps accelerate migration for common platforms like ADVANCE, BLACKBAUD, etc.

In some cases, the cloud-based data system utilizes an institution specific schema, where the schema may be uploaded by a user or central administrator. Such a design not only enables mapping (e.g., database to database mapping, schema to schema mapping, connector to connector mapping, to name a few) to the data exchange, but also enables the data to be stored in the data exchange. In one non-limiting example, the present disclosure may support matching of vendor technologies, e.g., matching or mapping of BLACKBAUD schemas and connectors between SALESFORCE EDUCATION CLOUD or Independent Software Vendors (ISVs). In other cases, such as for supported systems, the system may automatically suggest common mappings that can then be modified (as needed).

In some cases, the cloud-based data system is configured to support native integrations (e.g., with Salesforce). Additionally, or alternatively, native integrations may include EDU-specific managed packages, such as, but not limited to, EDA, STUDENT SUCCESS HUB, ASCEND, MARKETING CLOUD, SALESFORCE CDP, TABLEAU, GITHUB, GITLAB, ORACLE SERVICES, RNL SERVICES, SLATE etc.

In one example, the disclosure is directed to a method comprising retrieving, by one or more processors, a legacy database from each of a plurality of domains of an organization to form a plurality of legacy databases, where at least two legacy databases in the plurality of legacy databases have a different data schema. The method further includes, for each of the plurality of legacy databases, retrieving, by the one or more processors, data from the respective legacy database, placing, by the one or more processors, the data from the respective legacy database into a respective unstructured database, and merging, by the one or more processors, the respective unstructured database into a principal data store designed to hold data for every domain of the plurality of domains.

In another example, the disclosure is directed to a computing device comprising one or more processors configured to retrieve a legacy database from each of a plurality of domains of an organization to form a plurality of legacy databases, where at least two legacy databases in the plurality of legacy databases have a different data schema. The one or more processors are further configured to, for each of the plurality of legacy databases, retrieve data from the respective legacy database, place the data from the respective legacy database into a respective unstructured database, and merge the respective unstructured database into a principal data store designed to hold data for every domain of the plurality of domains.

In another example, the disclosure is directed to a non-transitory computer-readable storage medium containing instructions. The instructions, when executed, cause one or more processors to retrieve a legacy database from each of a plurality of domains of an organization to form a plurality of legacy databases, where at least two legacy databases in the plurality of legacy databases have a different data schema. The instructions, when executed, further cause the one or more processors to, for each of the plurality of legacy databases, retrieve data from the respective legacy database, place the data from the respective legacy database into a respective unstructured database, and merge the respective unstructured database into a principal data store designed to hold data for every domain of the plurality of domains.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present disclosure and therefore do not limit the scope of the invention. The drawings are not necessarily to scale, though examples can include the scale illustrated, and are intended for use in conjunction with the explanations in the following detailed description wherein like reference characters denote like elements. Examples of the present disclosure will hereinafter be described in conjunction with the appended drawings.

FIG. 1 is a schematic diagram showing some examples of data silos in a higher-education (Higher Ed) institution.

FIG. 2 is a block diagram illustrating a more detailed example of a computing device configured to perform the techniques described herein.

FIG. 3 illustrates a block diagram of a cloud-based data system, according to various aspects of the disclosure.

FIG. 4 illustrates a principal data store and a data package, according to various aspects of the disclosure.

FIG. 5 illustrates another block diagram of a cloud-based data system, according to various aspects of the disclosure.

FIG. 6A illustrates various examples of data ingestion tools, according to various aspects of the disclosure.

FIG. 6B illustrates various examples of data ingestion tools, according to various aspects of the disclosure.

FIG. 7 illustrates a block diagram showing an example architecture of a cloud-based data system, according to various aspects of the disclosure.

FIG. 8 illustrates an example of a data platform architecture, according to various aspects of the disclosure.

FIG. 9 illustrates an example of a cloud data platform layered architecture, according to various aspects of the disclosure.

FIG. 10 illustrates a flow diagram of an example method of migrating the plurality of legacy databases, in accordance with one or more aspects of the disclosure.

### DETAILED DESCRIPTION

The following detailed description is exemplary in nature and is not intended to limit the scope, applicability, or configuration of the techniques or systems described herein in any way. Rather, the following description provides some practical illustrations for implementing examples of the techniques or systems described herein. Those skilled in the art will recognize that many of the noted examples have a variety of suitable alternatives.

The present disclosure relates generally to cloud computing systems. In particular, but not by way of limitation, the present disclosure relates to systems, methods, apparatuses, and storage media for a cloud-based data management system for educational institutions.

The word “exemplary” is used herein to mean “serving as an example, instance, or illustration.” Any example described herein as “exemplary” is not necessarily to be construed as preferred or advantageous over other examples.

Preliminary note: the flowcharts and block diagrams in the following Figures illustrate the architecture, functionality, and operation of possible implementations of systems, methods and computer program products according to various examples of the present invention. In this regard, some blocks in these flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

The examples described below are not intended to limit the disclosure to the precise form disclosed, nor are they intended to be exhaustive. Rather, the example is presented to provide a description so that others skilled in the art may utilize its teachings. Technology continues to develop, and elements of the described and disclosed examples may be replaced by improved and enhanced items, however the teaching of the present disclosure inherently discloses elements used in examples incorporating technology available at the time of this disclosure.

The term algorithm as used herein, and generally in the art, refers to a self-consistent sequence of ordered steps that culminate in a desired result. These steps are those requiring manipulations of physical quantities. Usually, though not necessarily, these quantities take the form of electrical or magnetic pulses or signals capable of being stored, transferred, transformed, combined, compared, and otherwise manipulated. It is often convenient for reasons of abstraction or common usage to refer to these signals as bits, values, symbols, characters, display data, terms, numbers, or the like, as signifiers of the physical items or manifestations of such signals. It should be borne in mind, however, that all of these and similar terms are to be associated with the appropriate physical quantities and are merely used here as convenient labels applied to these quantities.

Some algorithms may use data structures for both inputting information and producing the desired result. Data structures facilitate data management by data processing systems and are not accessible except through sophisticated software systems. Data structures are not the information content of a memory, rather they represent specific electronic structural elements which impart or manifest a physical organization on the information stored in memory. More than mere abstraction, the data structures are specific electrical or magnetic structural elements in memory which simultaneously represent complex data accurately, often data modeling physical characteristics of related items, and provide increased efficiency in computer operation. By changing the organization and operation of data structures and the algorithms for manipulating data in such structures, the fundamental operation of the computing system may be changed and improved.

In the descriptions herein, operations and manipulations are sometimes described in terms, such as comparing, sorting, selecting, or adding, which are commonly associated with mental operations performed by a human operator. It should be understood that these terms are employed to provide a clear description of an example of the present disclosure, and no such human operator is necessary, nor desirable in most cases.

This requirement for machine implementation for the practical application of the algorithms is understood by those persons of skill in this art as not a duplication of human thought, rather as significantly more than such human capability. Useful machines for performing the operations of one or more examples of the present invention include general purpose digital computers or other similar devices. In all cases, the distinction between the method operations in operating a computer and the method of computation itself should be recognized. One or more examples of the present disclosure relate to methods and apparatus for operating a computer in processing electrical or other (e.g., mechanical, chemical) physical signals to generate other desired physical manifestations or signals. The computer operates on software modules, which are collections of signals stored on a media that represents a series of machine instructions that enable the computer processor to perform the machine instructions that implement the algorithmic steps. Such machine instructions may be the actual computer code the processor interprets to implement the instructions, or alternatively may be a higher-level coding of the instructions that is interpreted to obtain the actual computer code. The software module may also include a hardware component, wherein some aspects of the algorithm are performed by the circuitry itself rather than as a result of an instruction.

Some examples of the present disclosure rely on an apparatus for performing disclosed operations. This apparatus may be specifically constructed for the required purposes, or it may comprise a general purpose or configurable device, such as a computer selectively activated or reconfigured by a program comprising instructions stored to be accessible by the computer. The algorithms presented herein are not inherently related to any particular computer or other apparatus unless explicitly indicated as requiring particular hardware. In some cases, the computer programs may communicate or interact with other programs or equipment through signals configured to particular protocols which may or may not require specific hardware or programming to accomplish. In particular, various general-purpose machines may be used with programs written in accordance with the teachings herein, or it may prove more convenient to construct more specialized apparatus to perform the required method steps. The required structure for a variety of these machines will be apparent from the description below.

In the following description, several terms which are used frequently have specialized meanings in the present context.

In the description of examples herein, frequent use is made of the terms server, client, and client/server architecture. In this context, a server and client are each instantiations of a set of functions and capabilities intended to support distributed computing. These terms are often used to refer to a computer or computing machinery, yet it should be appreciated that the server or client function is provided by machine execution of program instructions, threads, modules, processes, or applications. The client computer and server computer are often, but not necessarily, geographically separated, although the salient aspect is that client and server each perform distinct, but complementary functions to accomplish a task or provide a service. The client and server accomplish this by exchanging data, messages, and often state information using a computer network, or multiple networks. It should be appreciated that in a client/server architecture for distributed computing, there are typically multiple servers and multiple clients, and they do not map to each other and further there may be more servers than clients or more clients than servers. A server is typically designed to interact with multiple clients. In some cases, a server may refer to a content delivery network (CDN), where a CDN refers to a geographically distributed group of servers which work together to provide fast delivery of Internet content. In some cases, a CDN facilitates quick transfer of assets needed for loading Internet content including, but not limited to, HTML pages, JavaScript files, stylesheets, images, and videos. Typically, CDNs may not host content, but help cache content (or data) at the network edge, which serves to optimize website performance.

In networks, bi-directional data communication (i.e., traffic) occurs through the transmission of encoded light, electrical, or radio signals over wire, fiber, analog, digital cellular, Wi-Fi, or personal communications service (PCS) media, or through multiple networks and media connected by gateways or routing devices. Signals may be transmitted through a physical medium such as wire or fiber, or via wireless technology using encoded radio waves. Much wireless data communication takes place across cellular systems using second generation technology such as code-division multiple access (CDMA), time division multiple access (TDMA), the Global System for Mobile Communications (GSM), Third Generation (wideband or 3G), Fourth Generation (broadband or 4G), Fifth Generation (5G), personal digital cellular (PDC), or through packet-data technology over analog systems such as cellular digital packet data (CDPD).

Additionally, or alternatively, various examples may involve transmissions over one or more wireless connections according to one or more 3rd Generation Partnership Project (3GPP), 3GPP Long Term Evolution (LTE), and/or 3GPP LTE-Advanced (LTE ADV) technologies and/or standards, including their revisions, progeny and variants. Some examples may additionally or alternatively involve transmissions according to one or more of Global System for Mobile Communications (GSM)/Enhanced Data Rates for GSM Evolution (EDGE), Universal Mobile Telecommunications System (UMTS)/High Speed Packet Access (HSPA), and/or GSM with General Packet Radio Service (GPRS) system (GSM/GPRS) technologies and/or standards, including their revisions, progeny and variants.

Examples of wireless mobile broadband technologies may also include without limitation any of the Institute of Electrical and Electronics Engineers (IEEE) 802.16m and/or 802.16p, International Mobile Telecommunications Advanced (IMT-ADV), Worldwide Interoperability for Microwave Access (WiMAX) and/or WiMAX II, Code Division Multiple Access (CDMA) 2000 (e.g., CDMA2000 1xRTT, CDMA2000 EV-DO, CDMA EV-DV, and so forth), High Performance Radio Metropolitan Area Network (HIPERMAN), Wireless Broadband (WiBro), High Speed Downlink Packet Access (HSDPA), High Speed Orthogonal Frequency-Division Multiplexing (OFDM) Packet Access (HSOPA), High-Speed Uplink Packet Access (HSUPA) technologies and/or standards, including their revisions, progeny and variants. The examples are not limited in this context.

In addition to transmission over one or more wireless connections, the techniques disclosed herein may involve transmission of content over one or more wired connections through one or more wired communication medium. Examples of wired communications media may include a wire, cable, metal leads, printed circuit board (PCB), backplane, switch fabric, semiconductor material, twisted-pair wire, co-axial cable, fiber optics, and so forth. The examples are not limited in this context.

Although the present application utilizes the term “higher education institutions” and other similar & related terms are used in describing various aspects of the invention, it is contemplated that at least some of these aspects may be applied both to other institutions similar to higher education institutions and other entities dissimilar to higher education institutions.

Like many industries, higher education institutions often struggle to fully utilize the vast amounts of data at their disposal. Typically, colleges and universities are responsible for securely managing valuable and sensitive information about their students, faculty, parents, donors, employees, volunteers, alumni, corporations, and both academic and community programs. In some instances, they are also responsible for making that data available across the institution/organization to maximize the value of the relationships with their students, faculty, etc. Currently used data management systems, especially those implemented at higher education institutions, are lacking in several regards. Specifically, several factors such as outdated software systems/data architectures and lack of technical staff with the appropriate skills to effectively use available technologies tend to hamper efforts to create a healthy and robust data management ecosystem. For example, some of the current systems utilized by universities were developed in the early 1980s and were not designed to seamlessly integrate with each other. This lack of integration poses several challenges, particularly in terms of migration, data management, and security risks. In some circumstances, migrating data from one system to another is a complex and time-consuming process due to the incompatible nature of these legacy systems. Furthermore, the lack of interoperability may hinder the efficient flow of data and information across different departments and functions within the university. Additionally, the use of outdated technologies, as well as the inability to hire and retain skilled staff to manage these legacy systems can pose significant risks. As technology evolves, so do the methods and tactics employed by malicious actors. Most legacy systems lack the measures to protect sensitive data and mitigate potential vulnerabilities. This exposes universities to higher risks, including data breaches and unauthorized access to sensitive information.

Higher education is in a state of rapid transformation, placing additional pressures on an institution's ability to deliver effective and efficient services to their community (prospect and current students, alumni, donors, and faculty/staff). In response, institutions are increasing their need and dependency on information to drive strategic planning and operational execution.

Historically, institutions develop their business and technology strategies independently, while simultaneously focusing on alignment. Additionally, institutions are experiencing/recognizing an acceleration and convergence of technology trends, forcing a shift of business expectations and transformation of organizational service delivery to its constituencies. This convergence, supported by research, suggest institutions (at all levels) are adopting and applying a more holistic approach to integrating technology and business processes.

Aspects of the present disclosure are directed to a system-of-record for helping organizations, such as, but not limited to, higher education institutions, manage their enterprise data management needs, host and integrate information across the entire constituent life cycle (i.e., recruiting and admissions, student success, advancement, and/or institution operations, to name a few). Using one or more data models, the system of the present disclosure may not only help identify information sharing opportunities, but also resolve them in one solution through data normalization and governance. This enables a system of record to be created for higher-ed institutions, which in turn allows them to safely gather, store, and/or manage their data within the data exchange. In some examples, the date exchange middleware described herein can be accessed on demand, for instance, for tasks related to data extraction and processing. Specifically, but without limitation, the data exchange can serve as a single system-of-record for full, system-wide enterprise data management needs by hosting and integrated information across the constituent life cycle (e.g., recruiting and admissions, student success, advancement, institution operations, to name a few). In some aspects, the present disclosure facilitates colleges/universities having a high-level of insight into their constituents' full lifecycle experience. As used herein, the term “constituent” may be used to refer to any of a student, faculty member, parent, donor, employee, volunteer, alumni, corporation, contract worker, and a partner institution. Other types of constituents are contemplated in different examples and the examples listed herein are not intended to be limiting.

In some aspects, the comprehensive master data management capabilities provided by the system of the present disclosure may allow colleges/universities the ability to manage information about their constituents (students, alumni, parents, employees, donors, corporations, and foundations) in a single source of truth (SSOT) by migration of data (loads or integrations) from multiple sources within institution(s) and normalizing the data. In some cases, the term “SSOT” refers to the practice of aggregating data from multiple systems (e.g., disparate systems) within an organization (e.g., higher education institution, such as a college or university) to a single location (i.e., a single physical location; a single memory source, such as a node/computing cluster at a data center). In some aspects, a SSOT is a “state of being” for an organization's data in that it allows the organization's data to be found via a single reference point. In some cases, implementing a SSOT architecture comprises structuring information models and associated data schemas such that every data element is mastered (or edited) in only one place. Typically, any possible linkages to a respective data element (possibly in other areas of the relational schema or even in distant federated databases) are by reference only. Because all other locations of the data just refer back to the primary SOT location, updates to the data element in the primary location propagate to the entire system, providing multiple advantages simultaneously: greater efficiency/productivity, easy prevention of mistaken inconsistencies (such as a duplicate value/copy somewhere being forgotten), and greatly simplified version control.

As used herein, the term “data migration” may refer to the process of moving or integrating data from previous-level applications or architecture into a new state. In some cases, the initiative may be related to a system-wide software or architectural upgrade initiative by the customer. In some circumstances, a client engagement may begin with a data migration project. During this data migration project, the system (e.g., system 300) may establish a relationship with the entity (e.g., client, such as a higher ed institution, a high school, middle school, or another applicable entity) prior to carrying out any large-scale movement and organization of data. In some examples, the data exchange infrastructure described above may also be built as part of, or during the, the data migration project.

Some non-limiting examples of the sub services associated with the data migration may include readiness (e.g., business process engineering, preemptive data cleanliness, agile OCM training, establishing data and project governance practices, information security, data storage, conversion and integration, reporting and dashboard evaluation, project planning), data conversion/integration/migration services (e.g., data cleanliness/governance, high-speed data migration, document management), data exchange services (e.g., solutions architecture, data storage, science, and artificial intelligence (AI) integration, cloud migration, user experience or UX, information security management, disaster recovery and business continuity).

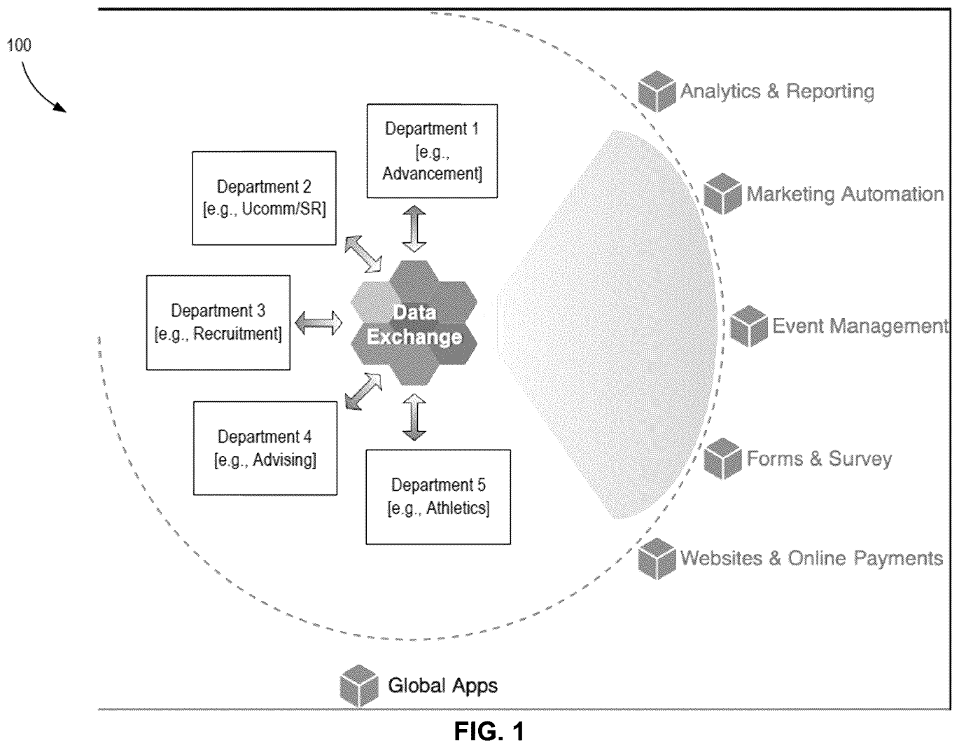

Some non-limiting examples of the sub services associated with the data exchange may include one or more of the sub services associated with the data migration (optional) and one or more of business implementation services (e.g., organizational readiness assessment, operational integration of data governance, IT governance, project governance, business operations governance, project management, process engineering, agile and OCM readiness), post implementation support (e.g., additional applications of the data exchange, business performance excellence or BPE, etc.). FIG. 1 depicts one non-limiting example of a data exchange model that may be built during an initial data migration for a client (e.g., higher ed institution, such as a college or university), which allows seamless, fast, and/or flexible data visualization and processing of data for one or more organizational inferences.

In some examples, the disclosed data migration and/or data exchange system(s) described herein may be built using, or may leverage, AI and machine learning (ML) technologies.

FIG. 1 illustrates a schematic diagram 100 showing some examples of data silos in a higher-ed institution. Specifically, FIG. 1 depicts a data exchange that is electronically, logically, and/or communicatively coupled with computing systems in a plurality of departments (e.g., Advancement, University Communications, Recruitment, Advising, Athletic departments). The data exchange comprises or is in communication with a plurality of global apps (e.g., apps for analytics and reporting, marketing automation, event management, forms and surveys, websites and online payments, to name a few).

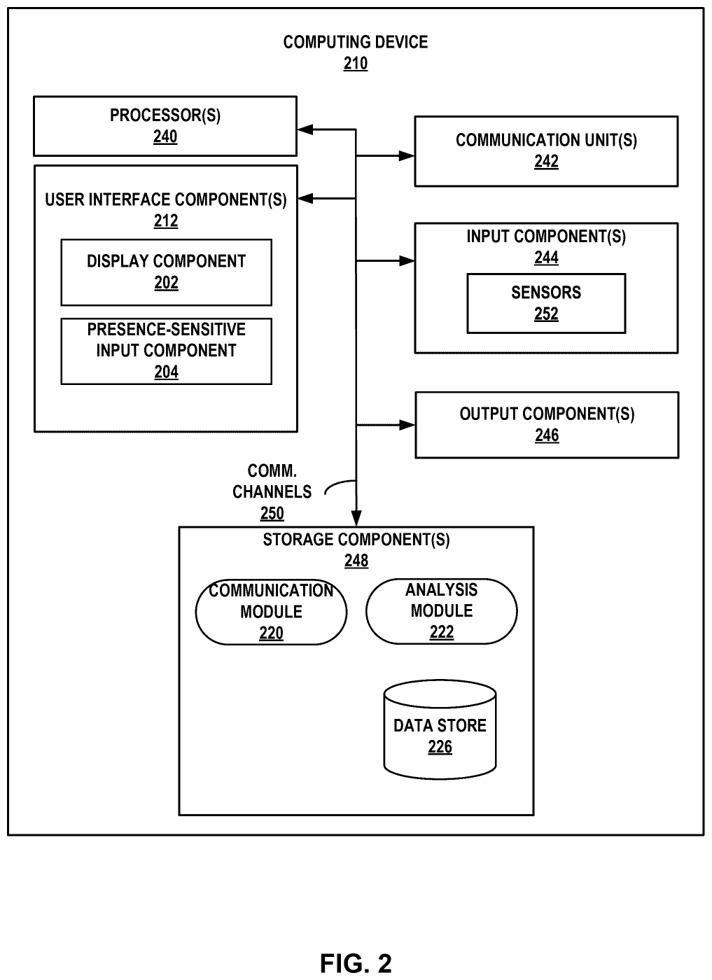

FIG. 2 is a block diagram illustrating a more detailed example of a computing device configured to perform the techniques described herein. FIG. 2 illustrates only one particular example of computing device 210, and many other examples of computing device 210 may be used in other instances and may include a subset of the components included in example computing device 210 or may include additional components not shown in FIG. 2.

Computing device 210 may be any computer with the processing power required to adequately execute the techniques described herein. For instance, computing device 210 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), an integrated computer system, a vehicle, a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

As shown in the example of FIG. 2, computing device 210 includes user interface components (UIC) 212, one or more processors 240, one or more communication units 242, one or more input components 244, one or more output components 246, and one or more storage components 248. UIC 212 includes display component 202 and presence-sensitive input component 204. Storage components 248 of computing device 210 include communication module 220, analysis module 222, and data store 226.

One or more processors 240 may implement functionality and/or execute instructions associated with computing device 210 to create a principal data store. That is, processors 240 may implement functionality and/or execute instructions associated with computing device 210 to retrieve data from various legacy databases, merge the data into a principal data store, and perform further analysis and updates on that principal data store.

Examples of processors 240 include any combination of application processors, display controllers, auxiliary processors, one or more sensor hubs, and any other hardware configured to function as a processor, a processing unit, or a processing device, including dedicated graphical processing units (GPUs). Modules 220 and 222 may be operable by processors 240 to perform various actions, operations, or functions of computing device 210. For example, processors 240 of computing device 210 may retrieve and execute instructions stored by storage components 248 that cause processors 240 to perform the operations described with respect to modules 220 and 222. The instructions, when executed by processors 240, may cause computing device 210 to retrieve data from various legacy databases, merge the data into a principal data store, and perform further analysis and updates on that principal data store.

Communication module 220 may execute locally (e.g., at processors 240) to provide functions associated with communicating with various domains to retrieve legacy databases, sending data back to the various domains, and receiving further updates to the principal data store. In some examples, communication module 220 may act as an interface to a remote service accessible to computing device 210. For example, communication module 220 may be an interface or application programming interface (API) to a remote server that communicates with various domains to retrieve legacy databases, sends data back to the various domains, and receives further updates to the principal data store.

In some examples, analysis module 222 may execute locally (e.g., at processors 240) to provide functions associated with creating the principal data store and garnering insights from how the principal data store is accessed by various domains. In some examples, analysis module 222 may act as an interface to a remote service accessible to computing device 210. For example, analysis module 222 may be an interface or application programming interface (API) to a remote server that creates the principal data store and garners insights from how the principal data store is accessed by various domains.

One or more storage components 248 within computing device 210 may store information for processing during operation of computing device 210 (e.g., computing device 210 may store data accessed by modules 220 and 222 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220 and 222 and data store 226. Storage components 248 may include a memory configured to store data or other information associated with modules 220 and 222 and data store 226. Data store 226 may be any one or more data storage locations, either physical or virtual, such as a principal data store or a plurality of temporary unstructured databases used for migrating data to the principal data store from legacy databases.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on one or more networks. Examples of communication units 242 include a network interface card (e.g., such as an Ethernet card), an optical transceiver, a radio frequency transceiver, a GPS receiver, a radio-frequency identification (RFID) transceiver, a near-field communication (NFC) transceiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 244 of computing device 210, in one example, include a presence-sensitive input device (e.g., a touch sensitive screen, a PSD), mouse, keyboard, voice responsive system, camera, microphone or any other type of device for detecting input from a human or machine. In some examples, input components 244 may include one or more sensor components (e.g., sensors 252). Sensors 252 may include one or more biometric sensors (e.g., fingerprint sensors, retina scanners, vocal input sensors/microphones, facial recognition sensors, cameras), one or more location sensors (e.g., GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a radar sensor, a lidar sensor, a sonar sensor, a heart rate sensor, magnetometer, glucose sensor, olfactory sensor, compass sensor, or a step counter sensor.

One or more output components 246 of computing device 210 may generate output in a selected modality. Examples of modalities may include a tactile notification, audible notification, visual notification, machine generated voice notification, or other modalities. Output components 246 of computing device 210, in one example, include a presence-sensitive display, a sound card, a video graphics adapter card, a speaker, a cathode ray tube (CRT) monitor, a liquid crystal display (LCD), a light emitting diode (LED) display, an organic LED (OLED) display, a virtual/augmented/extended reality (VR/AR/XR) system, a three-dimensional display, or any other type of device for generating output to a human or machine in a selected modality.

UIC 212 of computing device 210 may include display component 202 and presence-sensitive input component 204. Display component 202 may be a screen, such as any of the displays or systems described with respect to output components 246, at which information (e.g., a visual indication) is displayed by UIC 212 while presence-sensitive input component 204 may detect an object at and/or near display component 202.

While illustrated as an internal component of computing device 210, UIC 212 may also represent an external component that shares a data path with computing device 210 for transmitting and/or receiving input and output. For instance, in one example, UIC 212 represents a built-in component of computing device 210 located within and physically connected to the external packaging of computing device 210 (e.g., a screen on a mobile phone). In another example, UIC 212 represents an external component of computing device 210 located outside and physically separated from the packaging or housing of computing device 210 (e.g., a monitor, a projector, etc. that shares a wired and/or wireless data path with computing device 210).

UIC 212 of computing device 210 may detect two-dimensional and/or three-dimensional gestures as input from a user of computing device 210. For instance, a sensor of UIC 212 may detect a user's movement (e.g., moving a hand, an arm, a pen, a stylus, a tactile object, etc.) within a threshold distance of the sensor of UIC 212. UIC 212 may determine a two or three-dimensional vector representation of the movement and correlate the vector representation to a gesture input (e.g., a hand-wave, a pinch, a clap, a pen stroke, etc.) that has multiple dimensions. In other words, UIC 212 can detect a multi-dimension gesture without requiring the user to gesture at or near a screen or surface at which UIC 212 outputs information for display. Instead, UIC 212 can detect a multi-dimensional gesture performed at or near a sensor which may or may not be located near the screen or surface at which UIC 212 outputs information for display.

In accordance with the techniques of this disclosure, communication module 220 may retrieve a legacy database from each of a plurality of domains of an organization to form a plurality of legacy databases. In some examples, at least two legacy databases in the plurality of legacy databases have a different data schema, meaning a direct migration of the data from the database may not provide adequate results.

For each of the plurality of legacy databases, communication module 220 may retrieve data from the respective legacy database. Analysis module 222 may place the data from the respective legacy database into a respective unstructured database. Analysis module 222 may then merge the respective unstructured database into a principal data store designed to hold data for every domain of the plurality of domains.

In some instances, prior to merging the respective unstructured database into the principal data store, analysis module 222 may analyze the respective unstructured database to detect one or more errors in the data (e.g., incorrect spellings or typographical errors based on entries of similar data from other legacy databases, for example) of the respective unstructured database. If any errors are found to exist, analysis module 222 may correct the one or more errors in the data of the respective unstructured database to form a respective corrected unstructured database. Analysis module 222 may then merge the respective corrected unstructured database into the principal data store.

In some instances, in merging the respective unstructured database into the principal data store, analysis module 222 may detect similarity between data for a record of the respective unstructured database and data for a previously merged record of the principal data store. When merging the data, analysis module 222 may add, to the previously merged record of the principal data store, only the data for the record of the respective unstructured database that is not identical to any data already existing in the previously merged record of the principal data store.

As an example, in detecting the similarity between the data for the record of the respective unstructured database and the data for the previously merged record of the principal data store, analysis module 222 may detect that an identification field (e.g., an identification number, a first and last name combination, a date of birth, or any other field or combination of fields that would be unique to identify a single person). in the respective unstructured database is identical to an identification field in the principal data store. Additionally or alternatively, in detecting the similarity between the data for the record of the respective unstructured database and the data for the previously merged record of the principal data store further, analysis module 222 may detect that data in one or more secondary key fields (e.g., a first name, a last name, a mailing address, a parent's address, a parent's name, a date of birth, payment information, etc.) in the respective unstructured database are substantially similar to data in one or more secondary key fields in the principal data store.

In some examples, each domain of the plurality of domains is accessible through a respective portal. For instance, in a university or educational setting, each of an admissions department, an athletics department, a recruiting department, and advising department, and an academic department may be considered a separate domain, and each department may have a specific portal accessible to the users in those departments. For each of the plurality of domains, analysis module 222 may determine one or more legacy fields present in the respective legacy database for the respective domain. Analysis module 222 may further determine a principal field in the principal data store corresponding to each of the one or more legacy fields present in the respective legacy database for the respective domain to generate a respective set of one or more principal fields. Analysis module 222 may create a principal pointer for each principal field in the respective set of one or more principal fields to generate a respective set of one or more principal pointers. Communication module 220 may grant permission for one or more computing devices to access, via the respective portal, only the respective set of one or more principal fields in the principal data store accessible by the respective set of one or more principal pointers.

For example, an athletic department may have previously had a variety of fields in its legacy database specific to an athletic department, such as sporting events typically attended by the user, any sports played by the user, donations made by the user, or any other data relevant to the athletic department. The academic department, meanwhile, may not be interested in this data, instead storing data on the user's major, degrees earned, grades, and other information pertinent to an academic department. However, once this data is all included in a same principal data store, it may become superfluous for a user in the athletic department to have access to a person's academic information through the athletic department portal. To keep the user experience similar and streamlined, analysis module 222 may create the pointers to information that each domain needs access to, granting permissions to those domains to access only the data with pointers for that domain. By utilizing pointers, this also means that multiple domains may access some same fields, and any updates to those same fields would be automatically propagated to the other domains since the pointer is directed to a storage location in the principal data store and does not actually contain data in and of itself.

In some further instances, communication module 220 may receive a request from a computing device over a first portal of the plurality of portals, the request being for data in the respective set of one or more principal fields located by the respective set of one or more principal pointers for the first portal and for a first record in the principal data store. Communication module 220 may send, to the computing device over the first portal, the data in the respective set of one or more principal fields located by the respective set of one or more principal pointers for the first portal and for the first record in the principal data store. Communication module 220 may further receive updated data for a first principal field of the respective set of one or more principal fields located by a first principal pointer of the set of one or more principal pointers for the first record in the principal data store. Analysis module 222 may update the first principal field for the first record in the principal data store based on the updated data.

Similarly, communication module 220 may receive a request from a different computing device over a second portal of the plurality of portals, the request being for data in the respective set of one or more principal fields located by the respective set of one or more principal pointers for the second portal and for the first record in the principal data store, the respective set of one or more principal fields for the second portal including the first principal field. Communication module 220 may send, to the computing device over the first portal, the data in the respective set of one or more principal fields located by the respective set of one or more principal pointers for the first portal and for the first record in the principal data store, the data including the updated data for the first principal field.

In some examples, analysis module 222 may monitor updates to data in the principal data store from originating from each of the domains of the plurality of domains. Analysis module 222 may automatically generate insights for a record in the principal data store based on each particular update from each domain of the plurality of domains. For instance, with all of the data being in a single location, analysis module 222 may determine that a number of people in a certain major are disproportionately purchasing tickets to a certain athletic team's events, that people living in this freshman dormitory are disproportionately participating in theatre department events, or that a school's physics majors disproportionately hail from a particular county in a different state hundreds of miles from the school. With all of this previously separate data now being stored in a principal data store, connections between data points across departments can be analyzed such that the institution can understand and take advantage of these potential customizations to their offerings.

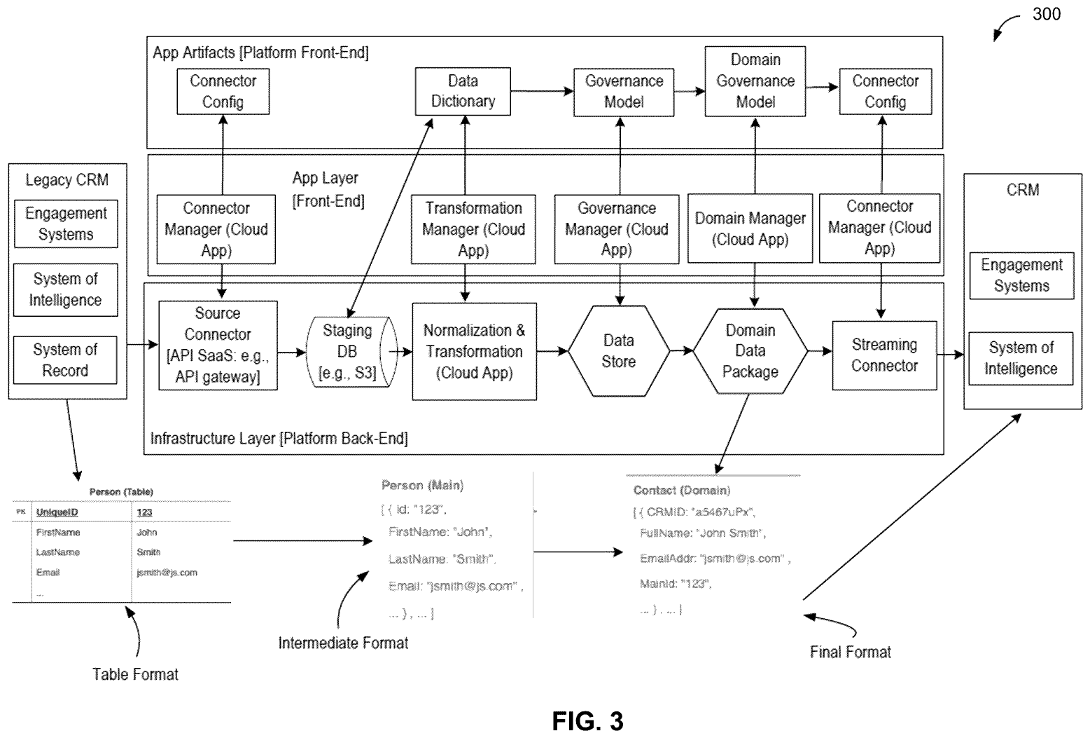

FIG. 3 illustrates a block diagram showing an architecture of a cloud-based data system 300, according to various aspects of the disclosure. As seen, the system/platform 200 comprises a front-end and a back-end, the front-end comprising application (app) artifacts and an app layer, and the back-end comprising an infrastructure layer.

In some cases, the app artifacts may comprise one or more of connector config, a data dictionary, a governance model, a domain governance model, and another connector config module (optional). The one or more elements/subcomponents of the app artifacts at the platform front-end may be embodied in hardware, software, or a combination thereof.

As seen, the app layer (front-end) may comprise one or more of a connector manager, a transformation manager, a governance manager, a domain manager, an accessibility manager, a security manager, and/or a connector manager. In some examples, the connector manager may be optional. One or more of the managers in the app layer may comprise a cloud app. In some examples, the app layer may comprise one or more cloud apps that cater to the requirements of higher education. These apps may encompass a wide range of artificial intelligence (AI) or machine learning (ML) capabilities, such as reporting, events management, recruiting, and marketing automation, to name a few non-limiting examples. Furthermore, these apps may be designed to address the specific needs of higher education institutions. As an example, it may be feasible to identify that there was a gala/sporting event hosted by an Engineering School of a university in partnership with a third-party (e.g., a private space technology company) based on leveraging the data available through the app and communication tools within the data exchange. Using this information, the system of the present disclosure can facilitate communications with the donor or assign a development officer to engage with representatives from the third-party during the gala/sporting event.

As seen, the infrastructure layer (back-end) may comprise one or more of a source connector (e.g., Software as a Service API, an API gateway), a staging database (e.g., S3 database), a normalization and transformation manager (e.g., a cloud app), a data store, a domain data package, and a streaming connector.

The one or more elements/subcomponents in the platform front-end and back-end may be in communication with each other using one or more dataflows (shown by way of the arrows in FIG. 3). The one or more dataflows may be unidirectional or bi-directional dataflows. In some cases, the platform/system may be in communication with one or more customer relationship management (CRM) systems, for instance, a legacy CRM (shown on the left in FIG. 3) and a new CRM (shown on the right in FIG. 3). As seen, the legacy CRM comprises one or more engagement systems (e.g., constituent/customer relationship management tools), a system of intelligence (e.g., the system that uses the data, this may be very limited in older technologies and may not use data efficiently or effectively), and a system of record (e.g., a system used to store and/or disperse data). Additionally, the new CRM also comprises one or more engagement systems and a system of intelligence. In this example, the platform/system 300 facilitates data migration from the legacy CRM to the new CRM. For instance, the system of record in the legacy CRM stores user information in a table format, as shown in the table on the lower left in FIG. 3. The platform/system parses the data/information in the table and transforms it into a different format (e.g., a format interpretable by the new CRM). As seen, the information in the table is transformed into an intermediate format. In some cases, the information in the intermediate format is further transformed into a third final format. In some examples, the system/platform relays the data in the intermediate and/or final formats to the new CRM.

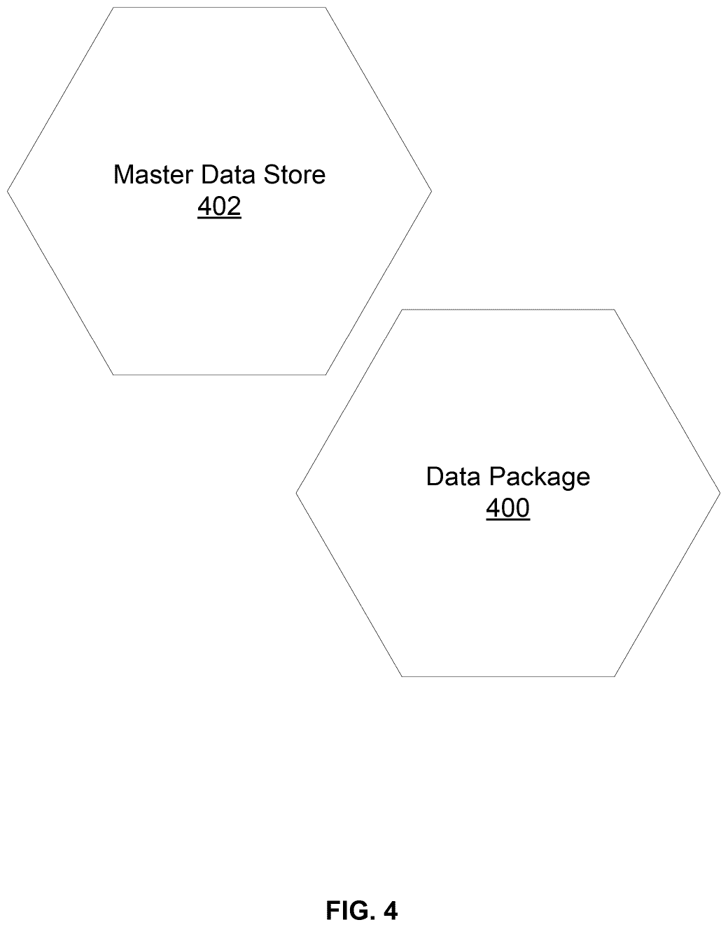

FIG. 4 illustrates an example of a principal data store 402, according to various aspects of the disclosure. The principal data store 402 implements one or more aspects of the data store in the infrastructure layer in FIG. 3. As seen, the principal data store is the primary source of truth (SOT) for an institution's common data, custom data, and/or global app data. In some examples, the master data may be standardized and normalized to fit an institution-wide master governance model (e.g., governance model in app artifacts in FIG. 3) and captured in one or more collection sets (e.g., common collections, custom collections, global app collections).

In some cases, the common collections may include default collections with pre-defined document object models (DOMs). Some non-limiting examples of common collections include “Person”, “Organization” and “User”, although different types of common collections are contemplated in different examples.

In some cases, the custom collections (e.g., shared collections) may comprise institution-specific collections used for capturing data not covered by the common set but that may need to be synchronized (or synced) across collection sets and/or domains. In some circumstances, entities/institutions may not employ inter exchange of data (i.e., data set is fragmented). Additionally, or alternatively, the central exchange (if any) employed by the institution may be utilized for reporting use only. To mitigate the issues posed by fragmented data sets, the system of the present disclosure may allow synchronization of data (where necessary), which enables the data to be managed dominantly in one location and make it usable by all or a majority of the sub systems associated with the institution.

In some cases, the global app collections may implement one or more aspects of the custom collections but may be tailored for one or more integrated global apps used across a plurality of domains.

In some instances, the collection sets described above may serve as the foundation for one or more domain-specific data packages (e.g., domain data package in the infrastructure layer in FIG. 3), further described below in relation to FIG. 4.

FIG. 4 also illustrates an example of a data package 400, according to various aspects of the disclosure. In some examples, a data package is an ancillary data set that serves as the system of record for a particular domain. In some examples, data collected from the principal data store may be parsed, transformed, and compiled along with domain-specific data to create a model. In some cases, the model may be configured to align to the domain's needs (e.g., business and/or architectural needs). In some cases, the data package(s) may comprise documents having shared and/or domain specific data. Additionally, or alternatively, data package(s) may be configured to simultaneously write to and receive updates from one or more of the principal data store and the domain's integrated systems (e.g., computing systems/servers specific to a department, such as recruiting, athletics, etc., at a college or a university).

In some cases, the data package may comprise (or may be communicatively coupled to) a master governance model, where the master governance model defines and maintains data relationships and sync rules between the principal data store and the data package. In some cases, the master governance model may also define access and Create, Read, Update and Delete (CRUD) permissions.

In some cases, a governance model for a domain (herein referred to as a domain governance model to distinguish it from the master governance model) may be used to manage the integration and CRUD capabilities between the data package and integrated systems specific to the domain.

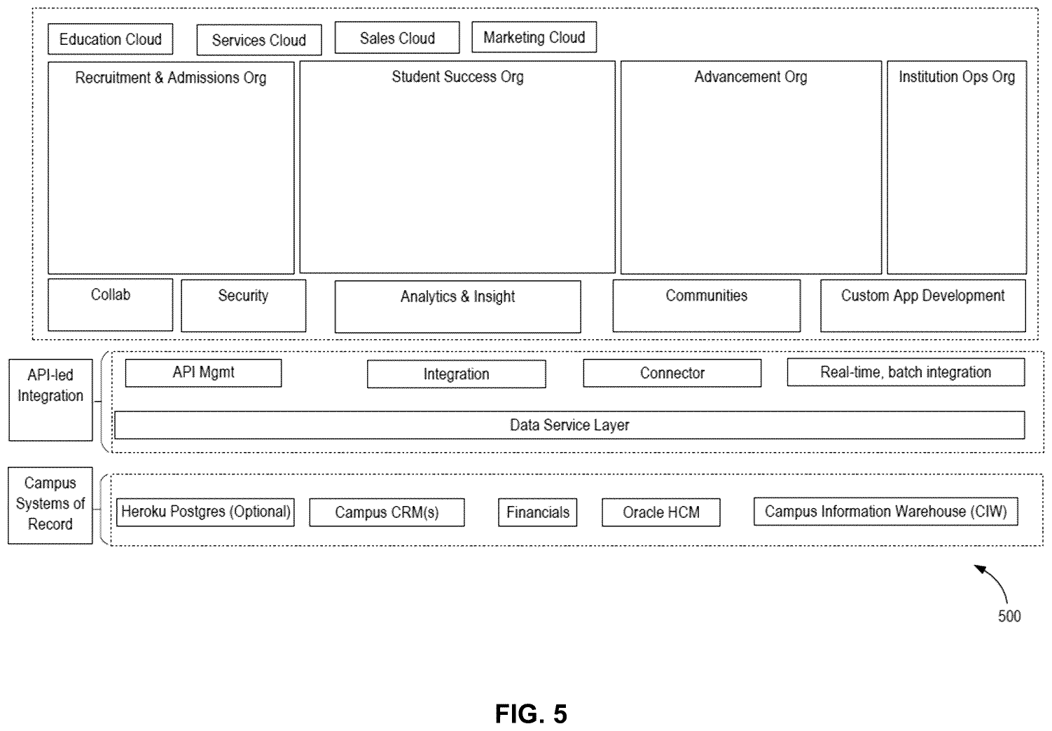

FIG. 5 illustrates another block diagram of a cloud-based data system 500, according to various aspects of the disclosure. Specifically, the cloud-based data system 500 in FIG. 5 implements a domain driven architecture that helps drive economies of scale, cost savings, and/or provides a higher degree of robustness as compared to prior art techniques. In this example, the cloud-based data system 500 comprises a front-end having an education cloud, a services cloud, a sales cloud, and a marketing cloud. One or more institutional organizations (e.g., recruitment and admissions organization, student success organization, advancement organization, institution operations organization) may access the cloud-based data system 500 via the front-end. In some examples, the cloud-based data system 500 allows users associated with the one or more organizations to access one or more apps (e.g., collaboration or collab apps, security apps, analytics and insight apps, communities apps, apps for custom app development) via the front-end.

In some examples, the back-end of the cloud system/platform 500 may support API-led integration, where the API-led integration may comprise API management, integration (e.g., MULESOFT integration), a connector (e.g., HEROKU connect, which is an add-on that synchronizes data between SALESFORCE and a HEROKU POSTGRES database), and real-time, batch integration. API-led integration may also provide (or support the use of) an ODIN/OSB layer, which enables information/data exchange with the campus/school systems of record. As seen, the campus/school systems of record may comprise one or more of a HEROKU POSTGRES database (although other databases are also contemplated in different examples), a campus CRM (e.g., SALESFORCE), financial system (e.g., ORACLE FUSION CLOUD FINANCIALS), a human resources system (e.g., ORACLE HUMAN CAPITAL MANAGEMENT or HCM), and a Campus Information Warehouse (CIW).

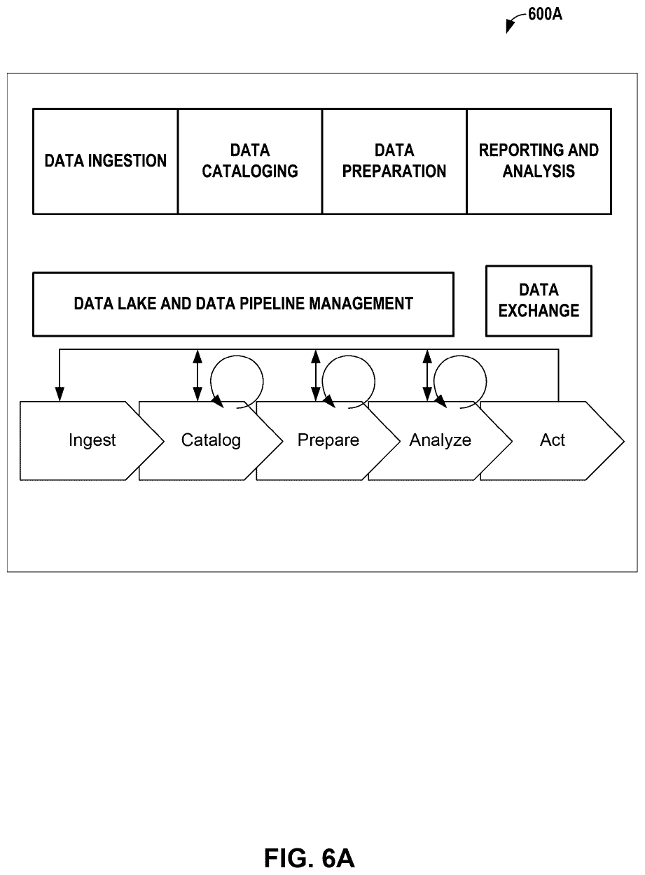

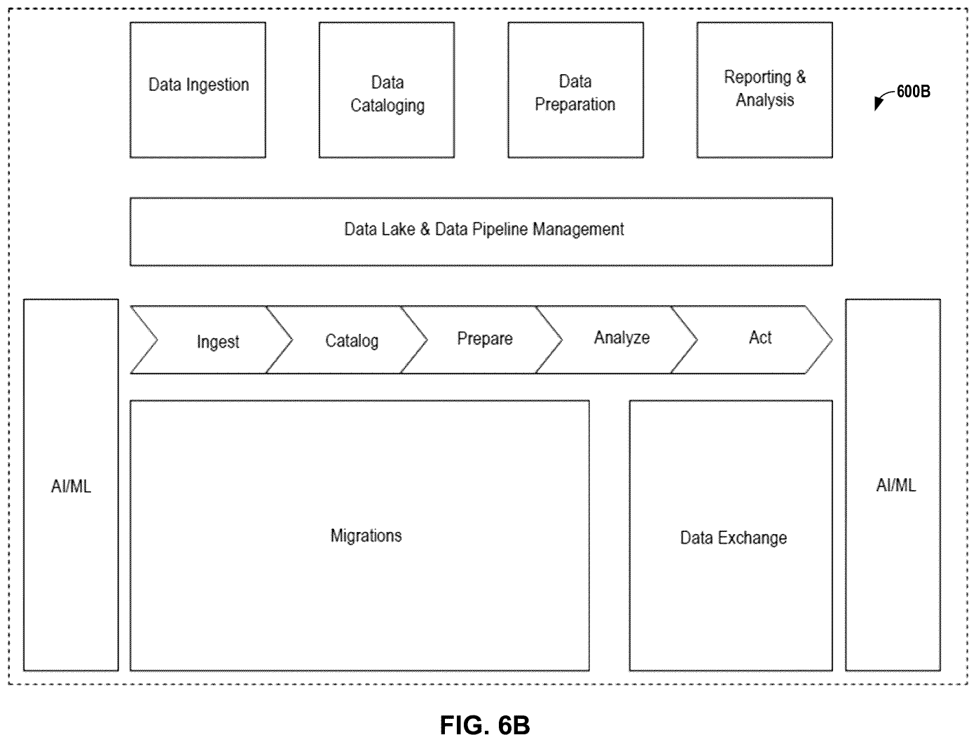

FIGS. 6A and 6B illustrate various examples of data ingestion tools, according to various aspects of the disclosure. In some instances, data ingestion tools help support the processes for bringing data into the analytics ecosystem.

A “healthy” data management ecosystem may strengthen an institution's ability to engage constituents (e.g., students, faculty, etc.), optimize operations, reduce costs, raise funds, manage risks, invest in high-priority areas, and/or invest in areas with a high return on investment (ROI). In some cases, the data management and governance practices implemented using the system of the present disclosure may enable higher-ed institutions to identify the entire inventory of desired information about a constituent so that data capture procedures can be implemented at the optimal stage in the constituent's life cycle. As an example, even though capturing the email or physical mailing address of a prospective student's parents may not be required during the student's recruitment and admissions process, capturing this extra information at the time of recruitment/admissions may be far easier and less expensive than attempting to solicit and integrate this information at a later time.

Some aspects of the present disclosure are directed to implementing optimal data management practices in higher-ed institutions using a cloud-based data system. Some key tenants of a sound/solid data management practice include: consistency, trust in the results, and accessibility.

When used in reference to data management practices, “consistency” refers to the use of a common language and data definitions across the organization, where the data definitions are cross-referenced against other; defining one or more data management roles, responsibilities, and escalation points; and/or having policies and procedures in place to adequately govern and manage critical data assets.

When used in reference to data management practices, “trust” refers to defining and/or managing data quality expectations with appropriate controls; having procedures in place to identify, manage, and/or remediate data-related issues; ensuring data flows in the organization are well-understood and transparent to various stakeholders/users of said data.

When used in reference to data management practices, “accessibility” means that the data platform/system is efficiently structured for the integration and/or organization of all key data; is easy to use; allows the right data to be available at the right time (i.e., provides accurate/relevant data in response to a user request); reporting and analytics tools, capabilities, and processes are aligned with the business needs of the organization; architecture standards and rules that govern how data is collected, managed, and/or shared are well document.

Some aspects of the present disclosure are directed to a cloud-based data system utilizing a data architecture, where the data architecture supports the desired data management practices described above, while also helping reduce long-term technology total cost of ownership (TCO). In some cases, the disclosed data architecture includes standards and governance practices that operationalize and optimize capabilities, including, but not limited to, information security, data storage, automation of business rules, data modeling, accessibility, data quality administration, technology standards, knowledge management, and data integration.

The system of the present disclosure provides an intuitive end-user interface/design (UX design). The UI of the present disclosure may be accessible from a wide-variety of user devices, such as, smartphones, laptops, tablets, desktop computers, etc.

As noted above, the system of the present disclosure is also directed to a system-of-record for helping organizations, such as, but not limited to, higher education institutions, manage their enterprise data management needs, host and integrate information across the entire constituent life cycle (i.e., recruiting and admissions, student success, advancement, and/or institution operations, to name a few). Using one or more data models, the system of the present disclosure may not only help identify information sharing opportunities, but also resolve them in one solution. In some aspects, the present disclosure facilitates colleges/universities having a high-level of insight into their constituents' full lifecycle experience. Furthermore, the data management capabilities provided by the system can help universities/colleges manage information about students, alumni, parents, etc., in a single source of truth (SSOT). As noted above, some aspects of the present disclosure, including at least the data migration and data exchange system(s) may be built using (or may leverage) AI/ML technologies and/or cloud intelligence.

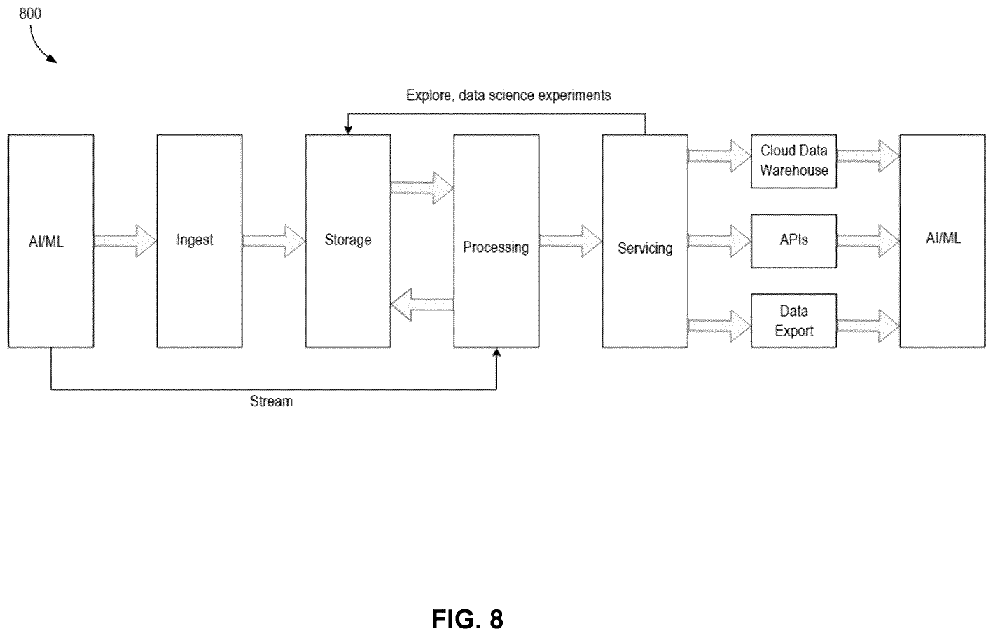

In some instances, the system (e.g., system 300, system(s) associated with 600-b or 800) may utilize AI/ML. In one non-limiting example, the AI may be integrated into the data ingestion stage (e.g., ingestion stage shown in FIGS. 6B, 8, and/or 9) and may be employed to streamline the data transfer process from one system (e.g., system 300) to another (e.g., system associated with a third party, such as Salesforce) through the higher education (or Higher Ed) schema. In this way, the system of the present disclosure may leverage AI/ML and/or predictive analysis techniques to help standardize and repeat the process to extract data from the source system, for instance, using common connectors. In some examples, the common connectors may be modified (e.g., schemas of common connectors may be modified with AI-enhanced modifications).

Once the data is extracted, the AI layer performs (or assists in performing) a set of data transformation(s) using predictive analysis, which helps in formatting and/or structuring data (e.g., common data elements) for the destination system. Combining data analysis, predictive analysis and schema analysis, the AI of the present disclosure helps map the transformed data to the respective field in the data schema of the new system, which serves to ensure an accurate and seamless data migration.

By employing AI in the ingestion data stage, the system of the present disclosure may help enhance the efficiency and/or accuracy of the data migration process. Furthermore, the AI's ability to understand complex data structures, automate repetitive tasks, and adapt to varying data sources may help reduce or minimize manual effort, human errors, etc., as compared to the prior art. In this way, aspects of the present disclosure may enable organizations (e.g., higher ed institutions, such as colleges or universities) to achieve faster and more reliable data migration, as compared to the prior art. Furthermore, the system of the present disclosure can help optimize the transition process for organizations and/or assist them in maximizing the benefits of their new systems.

Overall, the integration of AI with the system of the present disclosure, e.g., as shown in FIGS. 6B, 8, and/or 9, may help empower organizations with intelligent data management capabilities. Such a design may help optimize operational efficiency, data accuracy, and/or system integration via assessment of the data though repeatable checks and/or automations. In some instances, repeatable checks and/or automations may help provide higher levels of data hygiene, data standardization, and data normalization, to name a few non-limiting examples.

In some examples, “data migration” may involve transferring data from a first platform/system (e.g., legacy platform or system) to another platform/system (e.g., a new or modern system) in an efficient and/or speedy manner. In some cases, data migration may comprise tasks including, but not limited to, data cleansing, normalization, storage optimization, format conversion, and/or integration into the new system/platform. In some aspects, data migration may be employed to ensure a smooth/seamless transition while helping preserve data integrity and/or maximize the benefits of the new/upgraded platforms.

In some examples, the “data migration” utilities, e.g., powered by the data schema (ODS) and/or data model (ODM), enable the conversion of data from legacy Advancement CRM systems to more modern CRM platforms. Some non-limiting examples of modern CRM platforms include ASCEND, BLACKBAUD's RAISER's EDGE, the AFFINAQUEST suite of products, and ELLUCIAN's ADVANCE. It should be noted that other types of CRM platforms are contemplated in different examples and the examples listed herein are not intended to limit the scope or spirit of the disclosure. Clients can rely on these utilities to streamline the migration process, facilitating a seamless transition from their legacy systems.

In some examples, the concept of a data exchange can revolve around a unified system of record (SOR) that supports integrated data management across the entire constituent lifecycle in higher education domains (or other applicable domains). In some cases, a data exchange may serve as a central hub for seamlessly exchanging, storing, and/or managing data within the higher education sector. Furthermore, the data exchange may promote efficient data sharing, enhance collaboration, and/or provide a comprehensive view of constituents throughout their lifecycle. In some aspects, this can facilitate effective decision-making and/or streamline operations, as compared to the prior art.

In some examples, the system of the present disclosure can help in taking a more proactive approach to accelerate CRM implementations as compared to the prior art, e.g., by establishing repeatable and measurable business procedures. In some instances, these procedures can help ensure data accuracy, quality, and/or timeliness. Going beyond mere implementation, the system of the present disclosure may offer foundational standard operating procedures (SOPs) and migration templates. Furthermore, by leveraging its engagement tool, the system (e.g., system 300) may assist in assessing the technology landscape and/or resource availability to determine the most suitable (or optimal) approach for CRM implementations. In some examples, the system 300 can help bridge the gaps in client data, facilitate efficient data management across higher education domains, etc., for instance, by storing common data in a unified data schema, along with the detailed data exchange model (e.g., ODM).

In some instances, the higher education data models described herein may serve to provide business architectures and/or data architectures, where the business and/or data architectures represent how educational institutions are structured, the information utilized by said educational institutions, etc. Numerous models (e.g., provided by private third-party entitles, such as Salesforce Education Cloud; partly or fully funded by the government, such as Common Education Data Standards (CEDS) model) are contemplated in different examples. It should be noted that the high education data models described herein are exemplary only and not intended to be limiting. In other words, other types of higher ed data models known or contemplated in the art may be utilized in different examples without departing from the scope or spirit of the disclosure.

In some examples, the data schema (e.g., ODS) and/or data models (e.g., ODM) may help leverage the established data models described above in a way that makes the most sense for higher education. One common issue with legacy platforms is that they treat individuals (e.g., students, alumni, etc.) as separate entities even though they belong to the same household (e.g., one or more of the student's parents may be an alumni of the higher ed institutions). In some examples, the data models described herein may aim to address this issue through a process called “householding”. As an example, “householding” may help merge related individuals (e.g., student, alumni parent(s), alumni sibling(s)) into one household entity. In some instances, an individual record may be created for each person/individual (e.g., one for the student, one for the alumni parent). However, the record for each related person/individual may also be merged into the “household record”. In this way, the individual records for different related individuals/users may be accessible as separate individual records, or alternatively, as a merged household record. In some examples, the system of the present disclosure may help merge such records before transferring them to third-party platforms (e.g., SALESFORCE). In some examples, the system may be configured to allow both manual and/or automated data migration, data mergers, etc. For example, the disclosed AI/ML techniques can help automate data migration, data integration, data mergers, create “household records”, etc., via self-learning and/or self-improvement to reflect industry best practices and standards in higher education data management. In some examples, the system (e.g., system 300) may help align with these “best” practices to deliver effective data migration and integration solutions to institutions, help institutions overcome common challenges, and/or achieve a unified and comprehensive view of their data.

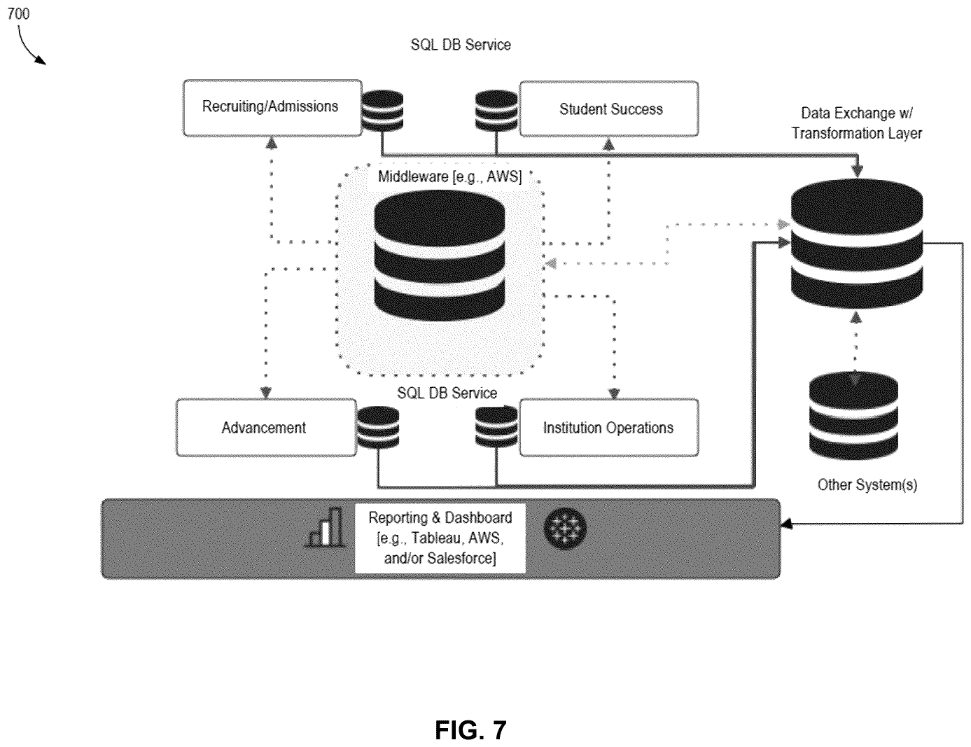

FIG. 7 depicts one non-limiting example of the architecture of the disclosed system. As seen, the disclosed system comprises middleware (e.g., AMAZON AWS) in communication with a plurality of disparate systems utilized by different subdivisions/departments (e.g., recruiting/admissions, student success, advancement, institution operations) of the higher-ed institution. The system also comprises (or is in communication with) one or more SQL DB services (e.g., HEROKU POSTGRES database). In some cases, the computing system(s) utilized by the different department(s) of the higher-ed institution may be electronically, logically, and/or communicatively coupled to one of the SQL DB services, as depicted in FIG. 7.

In some examples, the system also comprises a data exchange with a transformation layer (e.g., AWS/SNOWFLAKE data exchange with transformation layer) and one or more other systems (optional). The data exchange comprising the transformation layer may be communicatively coupled to a reporting and dashboard system (maybe a third-party system such as TABLEAU, AWS, and/or SALESFORCE).

Thus, as seen in FIG. 7, the system of the present disclosure enables high-speed data migration between disparate computing systems and allows data stored by various departments/subdivisions to be aggregated and compiled into a SSOT. Additionally, the cloud-based data system allows disparate computing systems to exchange data with a high degree of security to ensure personal data (e.g., personal identifiable information or PII) is stored in a safe and secure manner.

FIG. 8 illustrates an example of a data platform architecture 800, according to various aspects of the disclosure. Specifically, but without limitation, FIG. 8 depicts a high-level architecture of a data platform with four layers (ingestion, storage, processing, and servicing). As seen, the data platform architecture 800 includes an AI/ML module in addition to a data ingestion module, data storage module, data processing module, and a data servicing module. The data platform architecture 800 further includes (or is associated with) one or more of a cloud data warehouse, one or more application programming interfaces (APIs), and/or a data export module. It should be noted that one or more of the components/modules depicted in FIG. 8 may be optional in some examples.

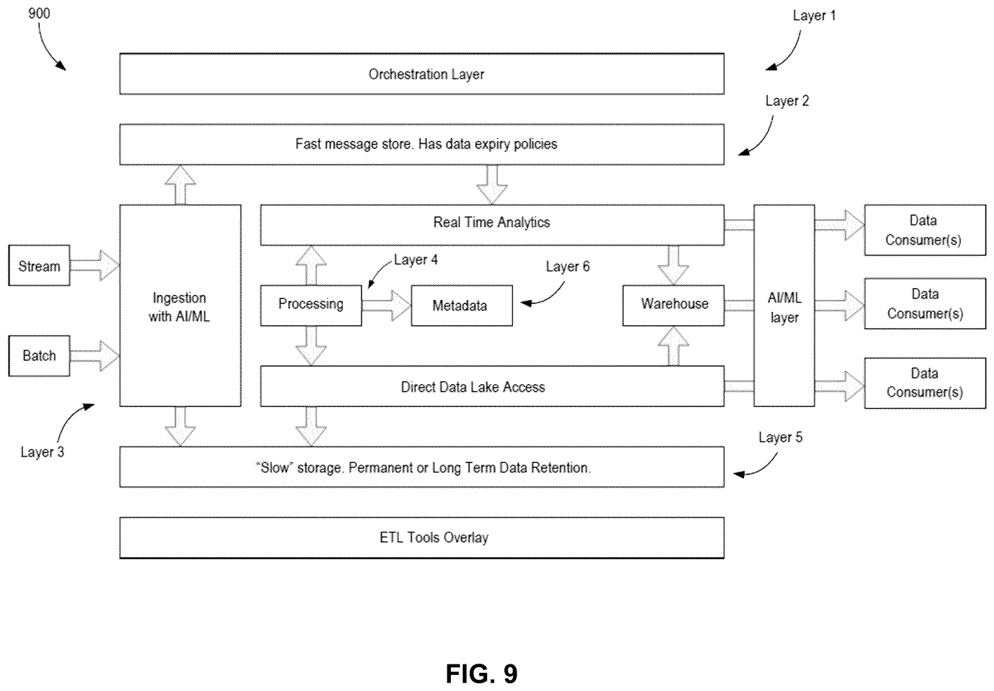

FIG. 9 illustrates an example of a cloud data platform layered architecture, according to various aspects of the disclosure. Specifically, but without limitation, FIG. 9 depicts a data platform architecture with a plurality of layers. The data platform architecture 900 depicted in FIG. 9 may implement one or more aspects of the data platform architecture 800 described above in relation to FIG. 8. In this example, the ingestion layer (e.g., layer 3 in FIG. 9) shows a distinction between batch and streaming ingest; the storage layer (e.g., layer 5) includes both slow and fast storage options; processing layer (e.g., layer 4) is configured to work with batch and streaming data, as well as the slow and fast storage options; metadata layers (e.g., shown within layer 4) help enhance the processing layer; and serving/servicing layers go beyond a data warehouse to also include other data consumers.

As used herein, the term “layer” refers to a functional component that performs a specific task in the data platform system. In practical terms, a layer is either a cloud service, an open source or commercial tool, or an application component. In some cases, a layer may be a combination of several components, such as a cloud service, open source tool, and/or an application component.

Some of the practical implications of the disclosed system include (but not limited to) reducing long-term IT total cost of ownership, providing more robust data management capabilities, and providing an open, scalable, and secure platform.

As an example, using the system of the present disclosure, feeding data from one internal system to another may no longer require the development and maintenance of a stand-alone integration program. Additionally, the data may be available in the data store (e.g., the Advancement department may be able to access alumni data by querying a different set of data or event packages/objects). Additionally, or alternatively, the system may allow standardized reporting across the platform, provide pre-built dashboards that depict the entire constituent experience and engagement levels based on industry practices, such as CASE, and enable the use of standard APIs that support additional data integration needs. In this way, the system may help reduce long-term IT total cost of ownership.

In some cases, the disclosed system facilitates more robust data management capabilities by (1) balancing routines, which mitigates the risk of data erosion, (2) accounting for data collision conflicts in advance via the use of a data model, where the data model accounts for the entire constituent lifecycle, (3) implementing real-time data validation controls that help account for the information needed across the entire constituent lifecycle, not just those needed to satisfy a specific business process at a point in time, (4) utilizing data quality reporting that enables data management practices to be defined and adopted up front, rather than after the fact, (4) employing cause-and-effect predictive models that can help forecast the constituents most likely to engage with the higher-ed institution, and/or (5) providing integrated 3rd party data feeds to enrich the university's propriety information including NCOA, wealth data, etc.

In some examples, the system of the present disclosure provides an open, scalable, and secure platform that adheres to data security compliance standards such as HIPAA, FERPA, etc. Additionally, or alternatively, the system can archive and backup data, based at least in part on compliance and business continuity requirements. Furthermore, the system is configured to integrate with one or more other third-party CRM solutions, such as, but not limited to, SALESFORCE, BLACKBAUD, AFFINAQUEST, etc.

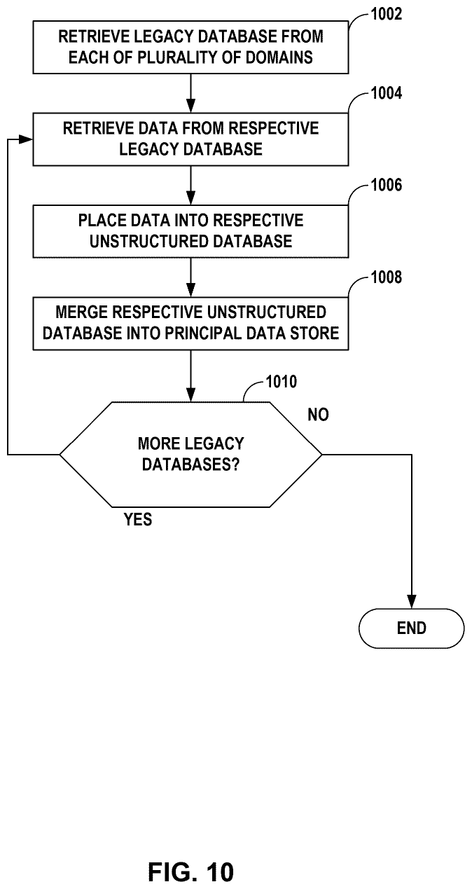

FIG. 10 is a flow chart illustrating an example mode of operation. The techniques of FIG. 10 may be performed by one or more processors of a computing device, such as computing device 210 illustrated in FIG. 2. For purposes of illustration only, the techniques of FIG. 10 are described within the context of computing device 210 of FIG. 2, although computing devices having configurations different than that of computing device 210 may perform the techniques of FIG. 10.

In accordance with the techniques of this disclosure, communication module 220 retrieves a legacy database from each of a plurality of domains of an organization to form a plurality of legacy databases, where at least two legacy databases in the plurality of legacy databases have a different data schema (1002). For each of the plurality of legacy databases, communication module 220 retrieves data from the respective legacy database (1004). Analysis module 222 places the data from the respective legacy database into a respective unstructured database (1006). Analysis module 222 then merges the respective unstructured database into a principal data store designed to hold data for every domain of the plurality of domains (1008). If there are additional legacy databases in the plurality of legacy databases (YES branch of 1010), then communication module 220 and analysis module 222 may repeat steps 1004, 1006, and 1008. If all legacy databases have been handled (NO branch of 1010), then the migration process may end.

Although the various examples have been described with reference to preferred implementations, persons skilled in the art will recognize that changes may be made in form and detail without departing from the spirit and scope thereof.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

It is contemplated that the various aspects, features, processes, and operations from the various embodiments may be used in any of the other embodiments unless expressly stated to the contrary. Certain operations illustrated may be implemented by a computer executing a computer program product on a non-transient, computer-readable storage medium, where the computer program product includes instructions causing the computer to execute one or more of the operations, or to issue commands to other devices to execute one or more operations.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as a pre-configured, stand-alone hardware element and/or as preprogrammed hardware elements (e.g., application specific integrated circuits, FPGAs, and digital signal processors), or other related components.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

While the various systems described above are separate implementations, any of the individual components, mechanisms, or devices, and related features and functionality, within the various system embodiments described in detail above can be incorporated into any of the other system embodiments herein.

The terms “about” and “substantially,” as used herein, refers to variation that can occur (including in numerical quantity or structure), for example, through typical measuring techniques and equipment, with respect to any quantifiable variable, including, but not limited to, mass, volume, time, distance, wave length, frequency, voltage, current, and electromagnetic field. Further, there is certain inadvertent error and variation in the real world that is likely through differences in the manufacture, source, or precision of the components used to make the various components or carry out the methods and the like. The terms “about” and “substantially” also encompass these variations. The term “about” and “substantially” can include any variation of 5% or 10%, or any amount—including any integer—between 0% and 10%. Further, whether or not modified by the term “about” or “substantially,” the claims include equivalents to the quantities or amounts.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range. Although the various embodiments have been described with reference to preferred implementations, persons skilled in the art will recognize that changes may be made in form and detail without departing from the spirit and scope thereof.

Various examples of the disclosure have been described. Any combination of the described systems, operations, or functions is contemplated. These and other examples are within the scope of the following claims.

1. A method comprising:
retrieving, by one or more processors, a legacy database from each of a plurality of domains of an organization to form a plurality of legacy databases, where at least two legacy databases in the plurality of legacy databases have a different data schema; and
for each of the plurality of legacy databases:
retrieving, by the one or more processors, data from the respective legacy database;
transforming, by the one or more processors, the data from the respective legacy database into a normalized format using a machine learning model trained to resolve schema differences and data inconsistencies, and placing the transformed data into a respective unstructured database, wherein the machine learning model is configured to automatically detect and map fields between disparate schemas based on learned patterns; and
merging, by the one or more processors, the respective unstructured database into a principal data store designed to hold data for every domain of the plurality of domains, wherein the merging comprises automatically detecting and resolving data conflicts using a rules engine that enforces data governance policies, and generating an audit log of all data transformations and merges, the audit log being stored in a tamper-evident data structure.

2. The method of claim 1, further comprising:
prior to merging the respective unstructured database into the principal data store:
analyzing, by the one or more processors, the respective unstructured database to detect one or more errors in the data of the respective unstructured database;
correcting, by the one or more processors, the one or more errors in the data of the respective unstructured database to form a respective corrected unstructured database; and
merging, by the one or more processors, the respective corrected unstructured database into the principal data store.

3. The method of claim 1, wherein merging the respective unstructured database into the principal data store comprises:
detecting, by the one or more processors, similarity between data for an record of the respective unstructured database and data for a previously merged record of the principal data store; and
adding, by the one or more processors and to the previously merged record of the principal data store, only the data for the record of the respective unstructured database that is not identical to any data already existing in the previously merged record of the principal data store.

4. The method of claim 3, wherein detecting the similarity between the data for the record of the respective unstructured database and the data for the previously merged record of the principal data store comprises:
detecting, by the one or more processors, that an identification field in the respective unstructured database is identical to an identification field in the principal data store.

5. The method of claim 4, wherein detecting the similarity between the data for the record of the respective unstructured database and the data for the previously merged record of the principal data store further comprises:
additionally detecting, by the one or more processors, that data in one or more secondary key fields in the respective unstructured database are substantially similar to data in one or more secondary key fields in the principal data store.

6. The method of claim 5, wherein the one or more secondary key fields comprise one or more of:
a first name,
a last name,
a mailing address,
a parent's address,
a parent's name,
a date of birth, and
payment information.

7. The method of claim 4, wherein the identification field comprises one or more of:
an identification number,
a first and last name combination, and
a date of birth.

8. The method of claim 1, wherein each domain of the plurality of domains is accessible through a respective portal, and wherein the method further comprises:
for each of the plurality of domains:
determining, by the one or more processors, one or more legacy fields present in the respective legacy database for the respective domain;
determining, by the one or more processors, a principal field in the principal data store corresponding to each of the one or more legacy fields present in the respective legacy database for the respective domain to generate a respective set of one or more principal fields;
creating, by the one or more processors, a principal pointer for each principal field in the respective set of one or more principal fields to generate a respective set of one or more principal pointers; and
granting, by the one or more processors, permission for one or more computing devices to access, via the respective portal, only the respective set of one or more principal fields in the principal data store accessible by the respective set of one or more principal pointers.

9. The method of claim 8, further comprising:
receiving, by the one or more processors, a request from a computing device over a first portal of the plurality of portals, the request being for data in the respective set of one or more principal fields located by the respective set of one or more principal pointers for the first portal and for a first record in the principal data store;
sending, by the one or more processors, and to the computing device over the first portal, the data in the respective set of one or more principal fields located by the respective set of one or more principal pointers for the first portal and for the first record in the principal data store;
receiving, by the one or more processors, updated data for a first principal field of the respective set of one or more principal fields located by a first principal pointer of the set of one or more principal pointers for the first record in the principal data store; and
updating, by the one or more processors, the first principal field for the first record in the principal data store based on the updated data.

10. The method of claim 9, further comprising:
receiving, by the one or more processors, a request from a different computing device over a second portal of the plurality of portals, the request being for data in the respective set of one or more principal fields located by the respective set of one or more principal pointers for the second portal and for the first record in the principal data store, the respective set of one or more principal fields for the second portal including the first principal field;
sending, by the one or more processors, and to the computing device over the first portal, the data in the respective set of one or more principal fields located by the respective set of one or more principal pointers for the first portal and for the first record in the principal data store, the data including the updated data for the first principal field.

11. The method of claim 1, further comprising:
monitoring, by the one or more processors, updates to data in the principal data store from originating from each of the domains of the plurality of domains; and
automatically generating, by the one or more processors, insights for an record in the principal data store based on each particular update from each domain of the plurality of domains.

12. A computing device comprising one or more processors configured to:
retrieve a legacy database from each of a plurality of domains of an organization to form a plurality of legacy databases, where at least two legacy databases in the plurality of legacy databases have a different data schema; and
for each of the plurality of legacy databases:
retrieve data from the respective legacy database;
transform the data from the respective legacy database into a normalized format using a machine learning model trained to resolve schema differences and data inconsistencies, and place the transformed data into a respective unstructured database, wherein the machine learning model is configured to automatically detect and map fields between disparate schemas based on learned patterns; and
merge the respective unstructured database into a principal data store designed to hold data for every domain of the plurality of domains, wherein the merging comprises automatically detecting and resolving data conflicts using a rules engine that enforces data governance policies, and generating an audit log of all data transformations and merges, the audit log being stored in a tamper-evident data structure.

13. The computing device of claim 12, wherein the one or more processors are further configured to:
prior to merging the respective unstructured database into the principal data store:
analyze the respective unstructured database to detect one or more errors in the data of the respective unstructured database;
correct the one or more errors in the data of the respective unstructured database to form a respective corrected unstructured database; and
merge the respective corrected unstructured database into the principal data store.

14. The computing device of claim 12, wherein the one or more processors being configured to merge the respective unstructured database into the principal data store comprise the one or more processors being configured to:
detect similarity between data for an record of the respective unstructured database and data for a previously merged record of the principal data store; and
add, to the previously merged record of the principal data store, only the data for the record of the respective unstructured database that is not identical to any data already existing in the previously merged record of the principal data store.

15. The computing device of claim 12, wherein each domain of the plurality of domains is accessible through a respective portal, and wherein the one or more processors are further configured to:
for each of the plurality of domains:
determine one or more legacy fields present in the respective legacy database for the respective domain;
determine a principal field in the principal data store corresponding to each of the one or more legacy fields present in the respective legacy database for the respective domain to generate a respective set of one or more principal fields;
create a principal pointer for each principal field in the respective set of one or more principal fields to generate a respective set of one or more principal pointers; and
grant permission for one or more computing devices to access, via the respective portal, only the respective set of one or more principal fields in the principal data store accessible by the respective set of one or more principal pointers.

16. The computing device of claim 12, wherein the one or more processors are further configured to:
monitor updates to data in the principal data store from originating from each of the domains of the plurality of domains; and
automatically generate insights for an record in the principal data store based on each particular update from each domain of the plurality of domains.

17. A non-transitory computer-readable storage medium comprising instructions having stored thereon instructions that, when executed, cause one or more processors of a computing device to:
retrieve a legacy database from each of a plurality of domains of an organization to form a plurality of legacy databases, where at least two legacy databases in the plurality of legacy databases have a different data schema; and
for each of the plurality of legacy databases:
retrieve data from the respective legacy database;
transform the data from the respective legacy database into a normalized format using a machine learning model trained to resolve schema differences and data inconsistencies, and place the transformed data into a respective unstructured database, wherein the machine learning model is configured to automatically detect and map fields between disparate schemas based on learned patterns; and
merge the respective unstructured database into a principal data store designed to hold data for every domain of the plurality of domains, wherein the merging comprises automatically detecting and resolving data conflicts using a rules engine that enforces data governance policies, and generating an audit log of all data transformations and merges, the audit log being stored in a tamper-evident data structure.

18. The non-transitory computer-readable storage medium of claim 17, wherein the instructions, when executed, further cause the one or more processors to:
prior to merging the respective unstructured database into the principal data store:
analyze the respective unstructured database to detect one or more errors in the data of the respective unstructured database;
correct the one or more errors in the data of the respective unstructured database to form a respective corrected unstructured database; and
merge the respective corrected unstructured database into the principal data store.

19. The non-transitory computer-readable storage medium of claim 17, wherein instructions that cause the one or more processors to merge the respective unstructured database into the principal data store comprise instructions that, when executed, further cause the one or more processors to:
detect similarity between data for an record of the respective unstructured database and data for a previously merged record of the principal data store; and
add, to the previously merged record of the principal data store, only the data for the record of the respective unstructured database that is not identical to any data already existing in the previously merged record of the principal data store.

20. The non-transitory computer-readable storage medium of claim 17, wherein each domain of the plurality of domains is accessible through a respective portal, and wherein the instructions, when executed, further cause the one or more processors to:
for each of the plurality of domains:
determine one or more legacy fields present in the respective legacy database for the respective domain;
determine a principal field in the principal data store corresponding to each of the one or more legacy fields present in the respective legacy database for the respective domain to generate a respective set of one or more principal fields;
create a principal pointer for each principal field in the respective set of one or more principal fields to generate a respective set of one or more principal pointers; and
grant permission for one or more computing devices to access, via the respective portal, only the respective set of one or more principal fields in the principal data store accessible by the respective set of one or more principal pointers.
